(19) United States
(12) Patent Application Publication
(10) Pub. No.: US 2014/0054150 A1
(43) Pub. Date: Feb. 27, 2014

(54) CARBON NANOTUBE TOUCH PANEL HAVING AT LEAST TWO CARBON NANOTUBE FILMS

(71) Applicant: TIANJIN FUNAYUANCHUNG TECHNOLOGY CO., LTD., Tianjin (CN)

(72) Inventor: HO-CHIEN WU, New Taipei (TW)

(73) Assignee: TIANJIN FUNAYUANCHUANG TECHNOLOGY CO.,LTD., Tianjin (CN)

(21) Appl. No.: 13/972,948

(22) Filed: Aug. 22, 2013

(30) Foreign Application Priority Data
Aug. 24, 2012 (CN) 2012103046154

(51) Int. Cl. H01H 13/807

(52) U.S. Cl. CPC H01H 13/807; Y10S 977/956; B82Y 15/00
USPC 200/5 A; 977/956

(57) ABSTRACT

A carbon nanotube (CNT) touch panel includes a base with a first touch region and a second touch region, a first CNT film placed on the first touch region of the base, a second CNT film placed on the second touch region of the base, and a flexible printed circuit (FPC) mounted on an edge of the base. A plurality of first connection wires and a plurality of second connection wires are formed on the base. The first connection wires interconnect the first CNT film and the FPC, and the second connection wires interconnect the second CNT film and the FPC.

### CROSS-REFERENCE TO RELATED APPLICATIONS

This application claims all benefits accruing under 35 U.S.C. §119 from China Patent Application No. CN201210304615.4 filed on Aug. 24, 2012 in the China

Intellectual Property Office, the content of which is hereby incorporated by reference in its entirety. This application is related to commonly-assigned applications entitled, “CARBON NANOTUBE TOUCH PANEL AND TOUCH DISPLAY APPARATUS USING SAME” filed **** (Atty. Docket No. US46684), “CARBON NANOTUBE TOUCH PANEL HAVING TWO CARBON NANOTUBE FILMS” filed **** (Atty. Docket No. US46691), “CARBON NANOTUBE TOUCH PANEL AND METHOD FOR MAKING SAME” filed **** (Atty. Docket No. US46693), “CARBON NANOTUBE TOUCH PANEL AND TOUCH DISPLAY APPARATUS USING SAME” filed **** (Atty. Docket No. US46694), “TOUCH PANEL AND TOUCH DISPLAY APPARATUS USING SAME” filed **** (Atty. Docket No. US46695), and “TOUCH PANEL AND TOUCH DISPLAY APPARATUS USING SAME” filed **** (Atty. Docket No. US46960).

### BACKGROUND

1. Technical Field

The present disclosure relates to touch sensing technologies, and more particularly, to a large-are carbon nanotube (CNT) touch panel having at least two CNT films.

2. Description of Related Art

Carbon nanotube (CNT) touch panels include a display assembly and a touch panel attached to the display assembly. CNTs used in CNT touch panels because of durablity. A CNT touch panel includes a plurality of CNTs arranged in parallel on a substrate. However, conductivity of the CNT decreases as a length of the CNT increases. This characteristic is a limit in design, and making a CNT touch panel with a large size is problematic.

What is needed is to provide a CNT touch panel that can overcome the above-described limitations.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a plan view of a CNT touch panel according to a first embodiment of the present disclosure.

FIG. 2 is a schematic view of a CNT film of the CNT touch panel of FIG. 1.

FIG. 3 is a plan view of a CNT touch panel according to a second embodiment of the present disclosure.

FIG. 4 is a plan view of a CNT touch panel according to a third embodiment of the present disclosure.

FIG. 5 is a plan view of a CNT touch panel according to a fourth embodiment of the present disclosure.

FIG. 6 is a plan view of a CNT touch panel according to a fifth embodiment of the present disclosure.

### DETAILED DESCRIPTION

Reference will be made to the drawings to describe various embodiments.

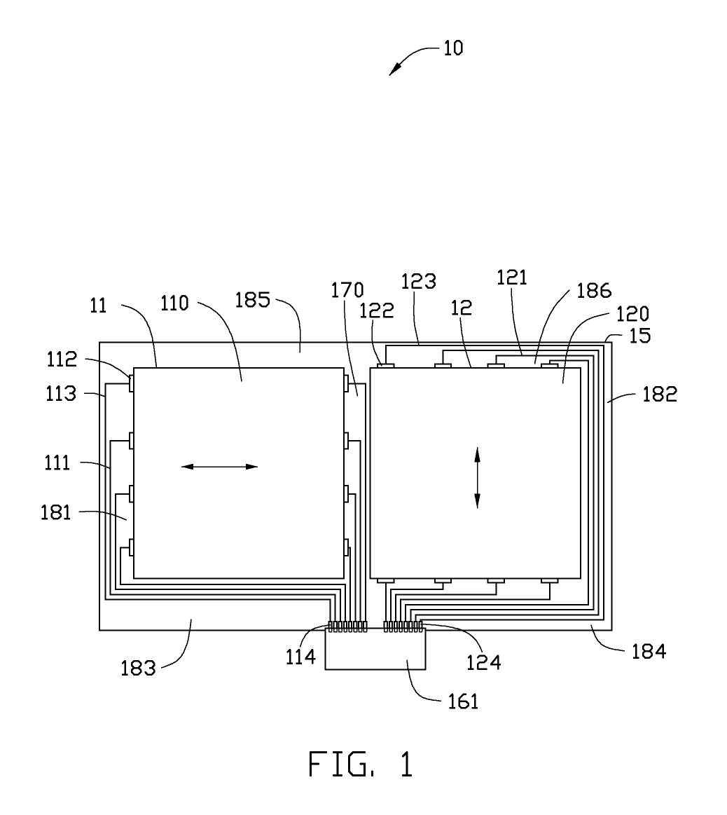

FIG. 1 shows a CNT touch panel 10 according to a first embodiment of the present disclosure. The CNT touch panel 10 includes a first CNT film 11, a second CNT film 12, a base 15 and a flexile printed circuit (FPC) 161. The base 15 may be a transparent glass or a plastic substrate, which includes a top surface. The first CNT film 11 and the second CNT film 12 are placed in parallel on the top surface of the base 15.

For example, the base 15 may define a touch area including a first touch region 110, a second touch region 120, and a gap region 170 between the first touch region 110 and the second touch region 120. The first touch region 110 and the second touch region 120 both have a rectangular shape. The first CNT film 11 and the second CNT film 12 are respectively adhered to the first touch region 110 and the second touch region 120, and a touch-insensitive gap is formed between the first CNT film 11 and the second CNT film 12 due to the gap region 170.

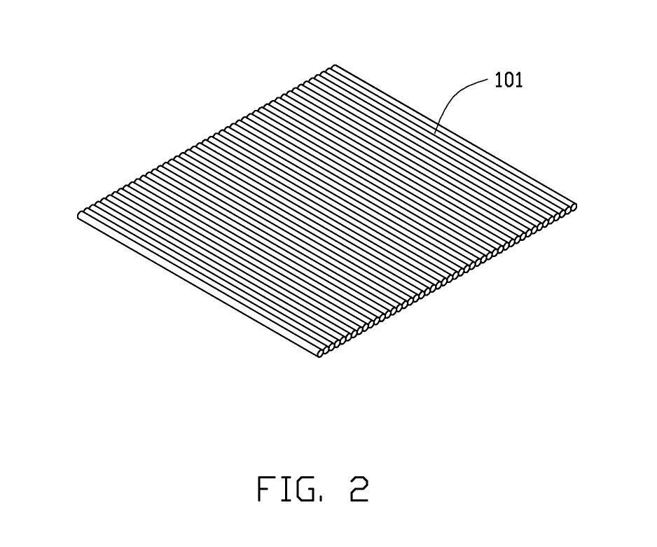

FIG. 2 shows that each of the first CNT film 11 and the second CNT film 12 includes a plurality of CNTs 101. The CNTs 101 are arranged parallel to each other. In the present embodiment, the CNTs 101 in the first CNT film 11 have an orientation perpendicular to an orientation of the CNTs 101 in the second CNT film 12; in other words, the first CNT film 11 and the second CNT film 12 are arranged such that one is oriented at ninety degrees to the other. The first CNT film 11 and the second CNT film 12 may sense touches applied to the CNT touch panel 10 and generate touch signals in accordance with the touches.

The touch area is located in a main central region of the base 15. The base 15 may further define a first side region 181, a second side region 112, a third side region 183, a fourth side region 184, a fifth side region 185, and a sixth side region 186, each of which is runs lengthwise. The first side region 181 and the second side region 182 are respectively located on opposite edges of the base 15, the first side region 181 and the second side region 182 are both perpendicular to the orientation of the CNTs 101 in the first CNT film 11, and parallel to the orientation of the CNTs 101 in the second CNT film. The third side region 183, the fourth side region 184, the fifth side region 185 and the sixth side region 186 are located on the other two edges of the base 15; moreover, the third side region 183 and the fourth side region 184 are located on a same side of the touch area, and the fifth side region 185 and the sixth side region 186 are located on an opposite side of the touch area.

In the embodiment, the first side region 181, the third side region 183, the gap region 170 and the fifth side region 185 are arranged end to end to form a periphery of the first touch region 110; the fourth side region 184, the second side region 182, the sixth side region 186 and the gap region 170 are arranged end to end to form a periphery of the second touch region 120.

A connection area between the third side region 183 and the fourth side region 184 are defined as a mounting region, and the FPC 161 is mounted on and is electrically connected to the mounting region. Moreover, the first side region 181, the third side region 183 and the gap region 170 are defined as wiring regions for forming connection wires between the first CNT film 11 and the FPC 161; and the fourth side region 184, the second side region 182 and the sixth side region 186 are defined as wiring regions for forming connection wires between the second CNT film 12 and the FPC 161.

In the present embodiment, the CNT touch panel 10 further includes a plurality first connection wires 111 formed on the wiring regions of the first CNT film 11 to interconnect the first CNT film 11 and the FPC 161, and a plurality of second connection wires 121 formed on the wiring regions of the second CNT film 12 to interconnect the second CNT film 12 and the FPC 161.

Each of the first connection wires 111 includes a first electrode 112, a first wire body 113 and a second electrode 114. The first electrode 112 is electrically connected to the first CNT film 11; for example, the first electrode 112 may be formed at the first side region 181 or the gap region 170, and is attached to the first CNT film 11. The second electrode 114 is formed on the mounting region in the third side region 183 and is attached to the FPC 161. The first wire body 113 is connected between the first electrode 112 and the second electrode 114.

Each of the second connection wires 121 includes a third electrode 122, a second wire body 123 and a fourth electrode 124. The third electrode 122 is electrically connected to the second CNT film 12; for example, the third electrode 122 may be formed at the fourth side region 184 or the sixth side region 186, and is attached to the second CNT film 12. The fourth electrode 124 is formed on the mounting region in the fourth side region 184 and is also attached to the FPC 161. The second wire body 123 is connected between the third electrode 122 and the fourth electrode 124.

Moreover, because some of the first connection wires 111 are formed in the gap region 170, the first electrode 112 and the first wire body 113 in the gap region 170 can be made of transparent conductive material, for example, Indium Tin Oxide (ITO) or Indium Zinc Oxide (IZO), and thus the gap region 170 does not impact a display quality when CNT touch panel 10 is positioned on a display panel.

In the mounting region, the second electrodes 114 and the fourth electrodes 124. The FPC 161 includes a plurality of connection electrodes which are also arranged in parallel, each of the connection electrodes is correspondingly attached to one of the second electrodes 114 or one of the fourth electrodes 124. In an alternative embodiment, the FPC 161 may be separated into two sub-FPCs, one is attached to the second electrodes 114, and the other one is attached to the fourth electrodes 124.

When the CNT touch panel 10 is in operation, scanning signals may be provided to the first CNT film 11 and the second CNT film 12 via the connection wires 111 and 121, and the first CNT film 11 and the second CNT film 12 may generate touch signals in response to applied touches. The touch signals may further be transmitted to the FPC 161 via the connection wires 111 and 121, and then be received by a processing unit to determine coordinates of the touches.

In the foregoing CNT touch panel 10, the first CNT film 11 and the second CNT film 12 are placed in parallel on the base 13; the first CNT film 11 and the second CNT film 12 cooperatively form a large-area CNT layer without the need of growing or creating long CNTs. As such, the CNT touch panel 10 can be made with a large size.

Moreover, because the orientation of the CNTs 101 in the second CNT film 12 is perpendicular to the orientation of CNTs 101 in the first CNT film 11, the second connection wires 121 can be formed with passing through the gap region 170, this can make the touch-insensitive gap between the first touch region 110 and the second touch region 120 be narrower.

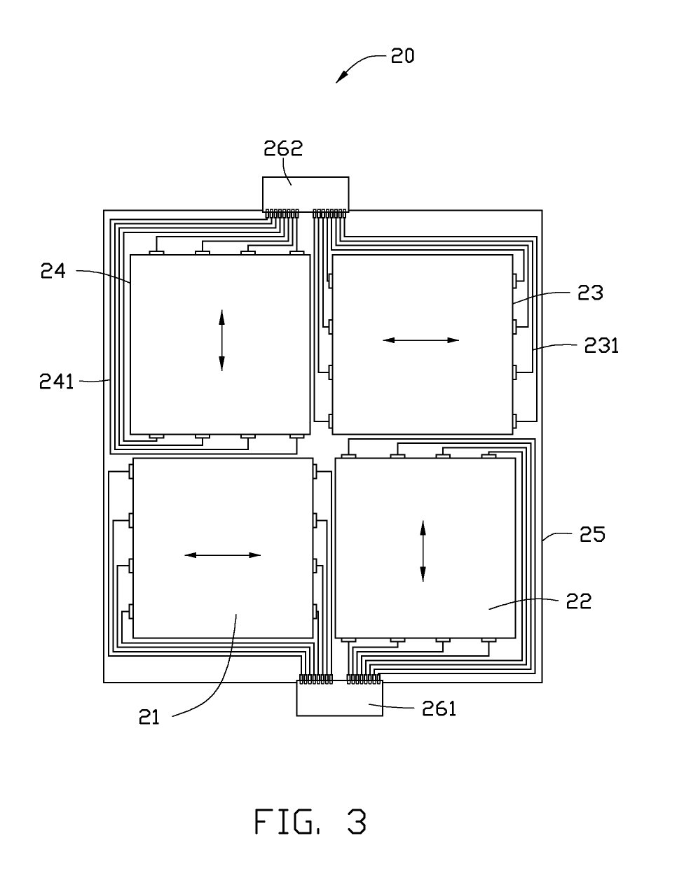

FIG. 3 shows a CNT touch panel 20 according to a second embodiment of the present disclosure. The CNT touch panel 20 is similar to the above-described CNT touch panel 10 according to the first embodiment, but differs in the following aspects. The CNT touch panel 20 further includes a third CNT film 23 and a fourth CNT film 24, in addition to a first CNT film 21 and a second CNT film 22.

The first CNT film 21, the second CNT film 22, the third CNT film 23 and the fourth CNT film 24 are arranged anticlockwise as a two-plus-two CNT film array. In the CNT touch panel 20, the second CNT film 22 is oriented at ninety degrees relative to the first CNT film 21, the third film 23 is oriented at one hundred and eighty degrees relative to the first CNT film 21, and the fourth CNT film 24 is oriented at two hundred and seventy degrees relative to the first CNT film 23.

Moreover, in addition to a first FPC 261 connected to the first CNT film 21 and the second CNT film 22, the CNT touch panel 20 comprises a second FPC 262, a plurality of third connection wires 231 and a plurality of fourth connection wires 241. The second FPC 262 is connected to the third CNT film 23 and the fourth CNT film 24; and the first FPC 261 and the second FPC 262 are mounted on two opposite edge of a base 25. The third connection wires 231 interconnect the third CNT film 23 and the second FPC 262, and the fourth connection wires 241 interconnect the fourth CNT film 24 and the second FPC 262. In the CNT touch panel 20, configurations and interconnections of the first CNT film 21, the second CNT film 22, the third CNT film 23 and the fourth CNT film 24 remain substantially the same as that in the CNT touch panel 10.

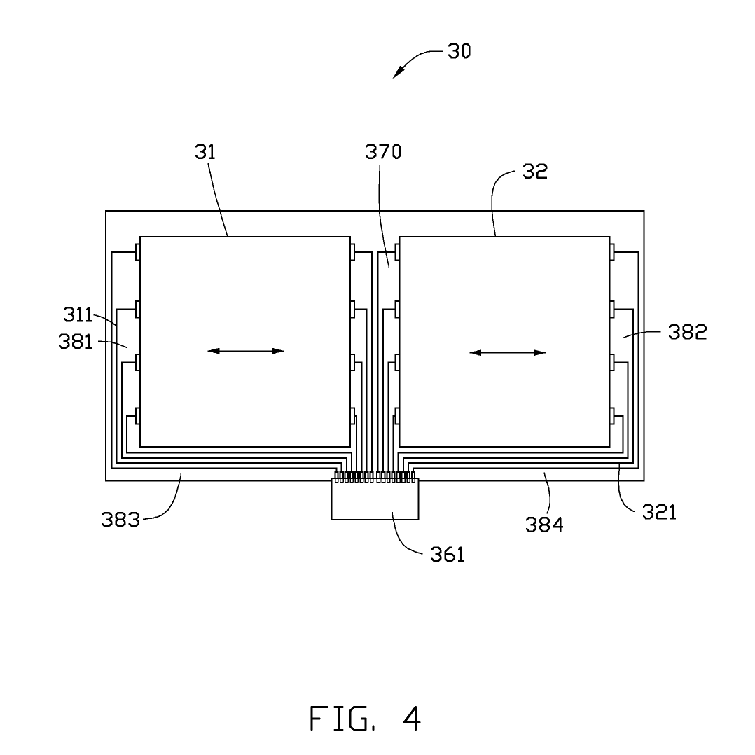

FIG. 4 shows that a CNT touch panel 30 according to a third embodiment of the present disclosure. The CNT touch panel 30 is similar to the above-described CNT touch panel 10 according to the first embodiment, but differs in the following aspects. In the CNT touch panel 30, the CNTs in a first CNT film 31 have an orientation the same as an orientation the CNTs in a second CNT film 32, and the orientation of the CNTs in both the first CNT film 31 and the second CNT film 32 is perpendicular to a first side region 381 and a second side region 382. Moreover, a plurality of second connection wires 321 for interconnecting the second CNT film 31 and an FPC 361 are formed symmetrical to a plurality of first connection wires 311 for interconnecting the first CNT film 32 and the FPC 361. In the embodiment, the first side region 381, a third side region 383 and a gap region 370 is defined as wiring regions of the first connection wires 311; and the second side region 382, a fourth side region 384 and the gap region 370 are defined as wiring regions of the second connection wires 321.

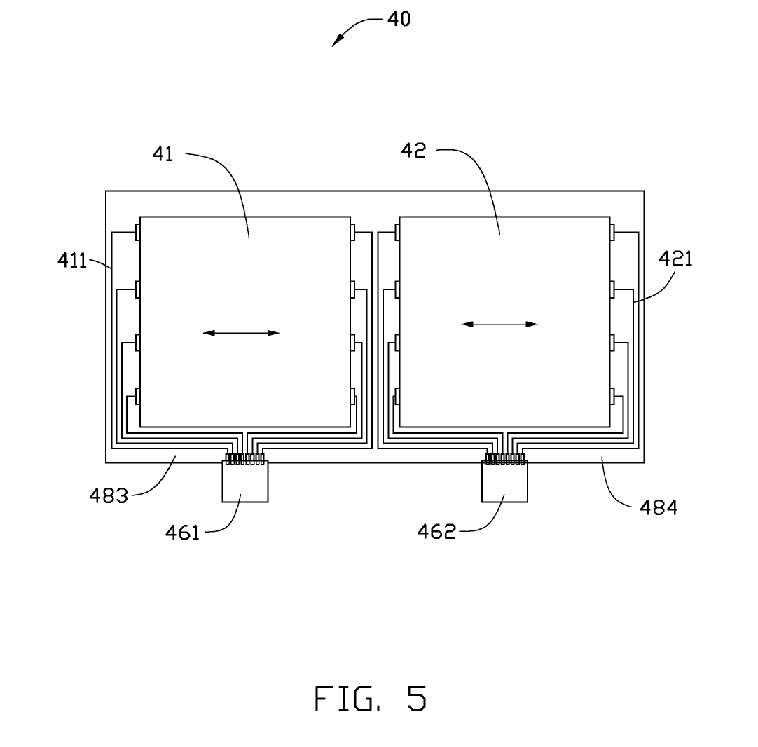

FIG. 5 shows a CNT touch panel 40 according to a fourth embodiment of the present disclosure. The CNT touch panel 40 is similar to the above-described CNT touch panel 30 according to the third embodiment, but differs in the following aspects. The CNT touch panel 40 includes a first FPC 461 and a second FPC 462. The first FPC 461 is mounted to a middle edge of a third side region 483, and is connected to a first CNT film 41 through a plurality of first connection wires 411. The second FPC 462 is mounted to a middle edge of a fourth side region 484, and is connected to a second CNT film 42 through a plurality of second connection wires 421.

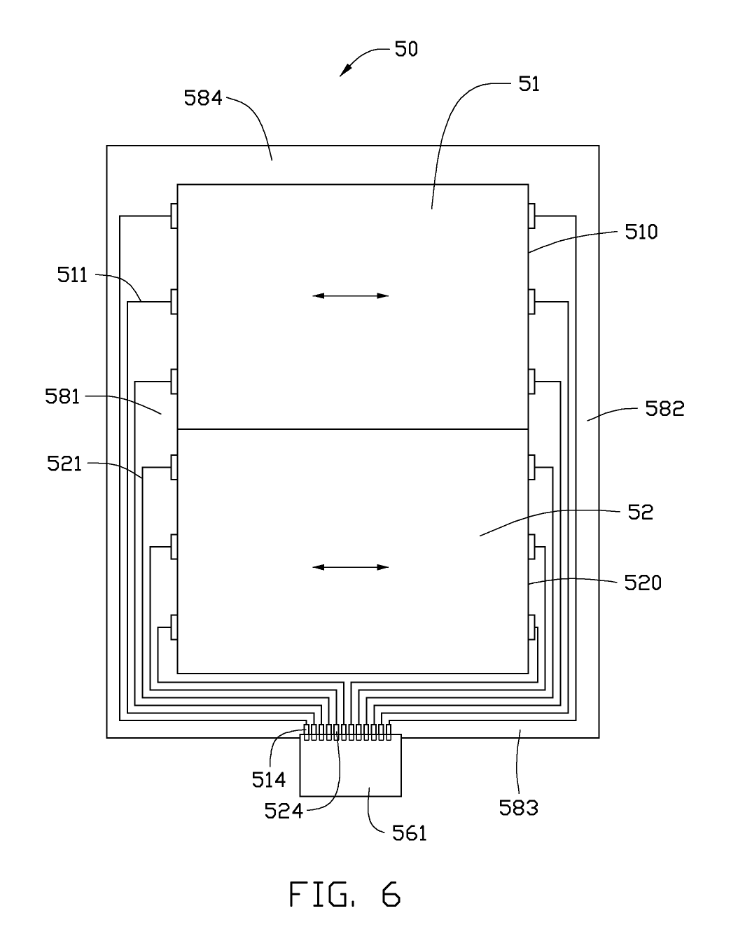

FIG. 6 shows that a CNT touch panel 50 according to a fifth embodiment of the present disclosure. The CNT touch panel 50 is similar to the above-described CNT touch panel 10 according to the first embodiment, but differs in the following aspects. The CNT touch panel 50 includes a base 55 defining a first touch region 510 and a second touch region 520 that is parallel to each other and may be successive, a first CNT film 51 and a second CNT film 52 are respectively placed in the first touch region 510 and a second touch region 520, and an orientation of CNTs in the first CNT film 51 is substantially the same as that of CNTs in the second CNT film 52.

Moreover, the base 55 also defines a first side region 581, a second side region 582, a third side region 583 and a fourth side region 584. The first side region 581, the third side region 583, the second side region 582 and the fourth side region 584 are arranged end to end to surround the first touch region 510 and a second touch region 520. The first side region 581 and the second side region 582 are perpendicular to the orientation of the CNTs in the first CNT film 51 and the second CNT film 52.

An FPC 561 is mounted on a middle edge of the third side region 583, and the CNT touch panel 50 further includes a plurality of first connection wires 511 for interconnecting the first CNT film 51 and the FPC 561, and a plurality of second connection wires 521 for interconnecting the second CNT film 52 and the FPC 561. The first side region 581, the second side region 582 and the third side region 583 are defined as wiring regions of both the first connection wires 511 and the second connection wires 521.

It is to be understood that even though numerous characteristics and advantages of the present embodiments have been set forth in the foregoing description, together with details of the structures and functions of the embodiments, the disclosure is illustrative only; and that changes may be made in detail, especially in the matters of shape, size, and arrangement of parts, within the principles of the embodiments, to the full extent indicated by the broad general meaning of the terms in which the appended claims are expressed.

What is claimed is:

1. A carbon nanotube (CNT)touch panel, comprising:
a base comprising a first touch region and a second touch region;
a first CNT film placed on the first touch region of the base;
a second CNT film placed on the second touch region of the base; and
a flexible printed circuit (FPC) mounted on an edge of the base;
wherein a plurality of first connection wires and a plurality of second connection wires are formed on the base, the first connection wires interconnect the first CNT film and the FPC, and the second connection wires interconnect the second CNT film and the FPC.

2. The CNT touch panel of claim 1, wherein the base further comprises a gap region between the first touch region and the second touch region; the first touch region, the gap region and the second touch region cooperatively constitute a touch area of the CNT touch panel.

3. The CNT touch panel of claim 2, wherein the base further comprises a first side region and a second side region, the first side region and the second side region are respectively located on opposite edges of the base.

4. The CNT touch panel of claim 3, wherein the base further comprises a third side region, a fourth side region, a fifth side region and a sixth side region; the third side region and the fourth side region are located on a same side of the touch area; and the fifth side region and the sixth side region are located on an opposite side of the touch area.

5. The CNT touch panel of claim 4, wherein each of the first CNT film and the second CNT film comprises a plurality of CNTs arranged in parallel, the CNTs in the first CNT film have an orientation perpendicular to an orientation of the CNTs in the second CNT film.

6. The CNT touch panel of claim 5, wherein the first side region, the third side region, the gap region and the fifth side region are arranged end to end to form a periphery of the first touch region; and the first side region, the third side region and the gap region are defined as wiring regions of the first connection wires.

7. The CNT touch panel of claim 6, wherein the fourth side region, the second side region, the sixth side region and the gap region are arranged end to end to form a periphery of the second touch region; and the fourth side region, the second side region and the sixth side region are defined as wiring regions of the second connection wires.

8. The CNT touch panel of claim 7, wherein the FPC is mounted on a mounting region defined at a connection area between the third side region and the fourth side region.

9. The CNT touch panel of claim 8, wherein each of the first connection wires comprises a first electrode, a first wire body and a second electrode; the first electrode is formed at the first side region or the gap region, and is attached to the first CNT film; the second electrode is formed on the mounting region in the third side region, and is attached to the FPC; the first wire body is connected between the first electrode and the second electrode.

10. The CNT touch panel of claim 8, wherein each of the second connection wires comprises a third electrode, a second wire body and a fourth electrode; the third electrode is formed at the fourth side region or the sixth side region, and is attached to the second CNT film; the fourth electrode is formed on the mounting region in the fourth side region, and is attached to the FPC; the second wire body is connected between the third electrode and the fourth electrode.

11. The CNT touch panel of claim 1, further comprising a third CNT film and a fourth CNT film; the first CNT film, the second CNT film, the third CNT film and the fourth CNT film are arranged counter clockwise as a two-plus-two CNT film array.

12. The CNT touch panel of claim 11, wherein the second CNT film is oriented at ninety degrees relative to the first CNT film, the third film is oriented at one hundred and eighty degrees relative to the first CNT film, and the fourth CNT film is oriented at two hundred and seventy degrees relative to the first CNT film.

13. The CNT touch panel of claim 11, further comprising another FPC, a plurality of third connection wires, and a plurality of fourth connection wires, wherein the third connection wires interconnect the third CNT film and the another FPC, and the fourth connection wires interconnect the fourth CNT film and the another FPC.

14. The CNT touch panel of claim 4, wherein each of the first CNT film and the second CNT film comprises a plurality of CNTs arranged in parallel, the CNTs in the first CNT film have an orientation same as an orientation of the CNTs in the second CNT film.

15. The CNT touch panel of claim 14, wherein the second connection wires are formed symmetrical to the first connection wires.

16. The CNT touch panel of claim 14, wherein the first side region, the third side region and the gap region are defined as wiring regions of the first connection wires; and the second side region, the fourth side region and the gap region are defined as wiring regions of the second connection wires.

17. The CNT touch panel of claim 16, wherein the FPC includes a first FPC and a second FPC, the first FPC is mounted to a middle edge of the third side region, and the second FPC is mounted to a middle edge of the fourth side region.

18. The CNT touch panel of claim 1, wherein the first touch region and the second touch region is parallel to each other and successive, and an orientation of CNTs in the first CNT film is substantially same as an orientation of of CNTs in the second CNT film.

19. The CNT touch panel of claim 18, wherein the base further comprises a first side region, a second side region, a third side region and a fourth side region; the first side region, the third side region, the second side region and the fourth side region are arranged end to end to surround the first touch region and a second touch region.

20. The CNT touch panel of claim 19, wherein the first side region, the second side region and the third side region are defined as wiring regions of both the first connection wires and the second connection wires.
